(19) United States
(12) Patent Application Publication
(10) Pub. No.: US 2024/0175647 A1
(43) Pub. Date: May 30, 2024

(54) CERAMIC TUBE PLUG

(71) Applicant: SAUDI ARABIAN OIL COMPANY, Dhahran (SA)

(72) Inventors: Haytham A. Albarrak, Dammam (SA); Abdullah M. Alqahtani, Dhahran (SA); Mohammed M. Alayesh, Dhahran (SA)

(73) Assignee: SAUDI ARABIAN OIL COMPANY, Dhahran (SA)

(21) Appl. No.: 18/060,293

(22) Filed: Nov. 30, 2022

(51) Int. Cl. F28F 11/04

(52) U.S. Cl. CPC F28F 11/04; F28F 2220/00

(57) ABSTRACT

A ceramic tube plugging system where a tube plug is inserted into the tube of the tubesheet and a ceramic ferrule is disposed on the tube plug. The ceramic ferrule is held on the tube plug by a locking mechanism. The locking mechanism may be a ceramic plug screw that passes through an opening in the ceramic ferrule and is attached to the tube plug by complementary threaded provision included in the tube plug.

### BACKGROUND

Oil refineries and large chemical plants have processes that generate heat from chemical and combustion reactions. Waste heat boilers or heat exchangers may be used to capture the generated heat by transferring the heat to a medium. A type of heat exchanger may consist of an enclosed pressure vessel with a bundle of tubes inside it. A medium such as a fluid may flow through the tubes, and another fluid may flow over the tubes in the pressure vessel. Heat is transferred between the two fluids by conduction and convection.

The tubes inside the heat exchanger may penetrate a tubesheet. The tubesheet is a support element that has holes to accept tubes in the pressure vessel and to arrange the tubes in desired configurations. The high temperatures sometimes cause damage and leaks in the tubes or at the junction of the tubesheet. Ceramic ferrules or refractory ferrules may be used on the hot face of the tubesheet to protect them from damage and high temperatures.

A damaged tube is typically plugged to continue the operations. Plugging a tube in a heat exchanger may be challenging because the tubesheet is lined with ferrules. The plugged tubesheet often requires protection from heat therefore monolithic refractory is used to substitute for the ceramic ferrule. In order to install monolithic refractory, an anchor is welded to a metallic plug. The installed refractory requires curing time and dry out. Also, the installed refractory cannot be inspected after drying out.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a ceramic tube plugging system where a tube plug is inserted into the tube of the tubesheet and a ceramic ferrule is disposed on the tube plug. The ceramic ferrule is held on the tube plug by a locking mechanism. The locking mechanism may be a ceramic plug screw that passes through an opening in the ceramic ferrule and is attached to the tube plug by complementary threaded provision included in the tube plug. The ceramic plug screw may include a plug component and threaded component.

In another aspect, embodiments disclosed herein relate to a method for plugging a tube of a tubesheet may include inserting a tube plug with a threaded provision into the tube in the tubesheet, disposing a ceramic ferrule with an opening on to the tube plug, attaching a ceramic plug screw into the complementary threaded provision of the tube plug. A threaded component of the ceramic plug screw may pass through the opening in the ceramic ferrule.

Other aspects and advantages of the claimed subject matter will be apparent from the following description and the appended claims.

### BRIEF DESCRIPTION OF DRAWINGS

FIG. 1 illustrates a perspective view of a tube plug inserted into a tube according to embodiments disclosed.

FIG. 2 illustrates a perspective view of a ceramic ferrule according to embodiments disclosed.

FIG. 3 illustrates a perspective view of a ceramic plug screw according to embodiments disclosed.

FIG. 4 illustrates a perspective view of a ceramic tube plugging system according to embodiments disclosed.

FIG. 5 illustrates a method of using a ceramic tube plugging system according to embodiments disclosed.

### DETAILED DESCRIPTION

In waste heat boilers, tubes may become damaged and fail causing process fluid inside the tubes to be exposed to flue gas. Accordingly, the waste heat boiler is removed from service to plug damaged tubes. Embodiments disclosed herein relate to a ceramic tube plugging system and method that may be used to plug a tube where the tubesheet holes are lined with ceramic ferrules.

Currently, a tube in a tubesheet is plugged by inserting a metallic plug in a tube. Next, a refractory anchor is welded to the plug. After welding, monolithic refractory material is installed onto the welded refractory anchor. The monolithic refractory material protects the tubes from heat exposure.

However, the current process has several limitations. The welding of anchors may damage adjacent tubes and tubesheets from heat stress. Further, the monolithic refractory process is time consuming because it requires material curing, heating, and drying prior to placing a waste heat boiler back in service. Also, the refractory material is of a different type than the material used to make the ceramic ferrules of the undamaged tubes. Also, the finished product cannot be inspected once drying is complete unless the equipment is reopened for inspection.

The ceramic tube plugging system may reduce the time required for plug installation by up to 80% and may reduce workmanship related failures caused by the plugging process. The ceramic tube plugging system has very low and negligible cost of repairs when compared to current products. Also, the components of the ceramic tube plugging system may easily be removed for quick inspections.

The ceramic tube plugging system may use a component (provision, portion, or part) to connect a tube plug to the ceramic ferrules thus eliminating the need for welding anchors. This may reduce the time required for installation of plugs and ensures the integrity of the plug by minimizing workmanship related failures caused when plugging tubesheet holes. This may also reduce the heat, stress, and damage to adjacent tubes that may be associated with welding. Further, since the ceramic ferrule used in ceramic tube plugging systems is similar to the original ceramic ferrule, there is no curing, heating, and drying time required.

One or more embodiments disclosed relates to a combination of a tube plug which may be used in the industry and a ceramic ferrule which may be used in covering a tubesheet. Combining these elements results in having a refractory ferrule wall that is aligned with no abnormalities due to welding or casting refractory on it.

In one aspect, embodiments disclosed herein relate to a ceramic tube plugging system and method. One or more embodiments may be useful for plugging tubes in tubesheets where tubes are lined with ceramic ferrules. The combined components function as a ceramic ferrule that is useful in isolating a tube and providing thermal protection and insulation to the tubesheet and tube bundle from thermal radiation.

The ceramic tube plugging system may comprise, a plug (or tube plug), a modified refractory ceramic ferrule (or ceramic ferrule), and a locking mechanism that may be a ceramic plug screw. The ceramic tube plug may be used to isolate the tube and provide thermal protection to the tubesheet and tube bundle. The ceramic tube plug is similar to the ceramic ferrule in design; however, the tube plug may contain an additional provision used to connect with the ceramic tube plug without requiring the welding of anchors.

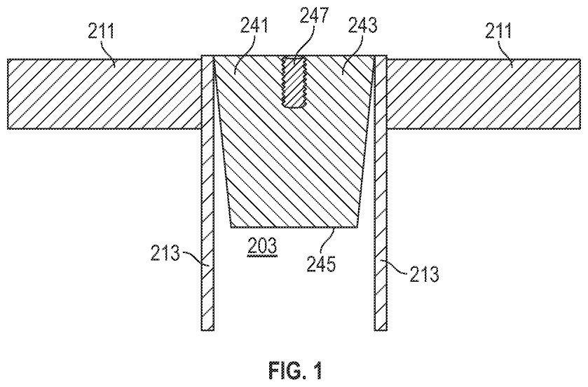

FIG. 1 shows a diagram of a portion of a tubesheet. The tubesheet 211 contains a tube 203 having a tube wall 213. A tube 203 may be a cylindrical hole configured to allow the flow of a medium. A tube 203 that is damaged may be plugged. A tube plug 241 may be configured to plug and isolate the tube 203 by being lodged between the tube wall 213. The tube plug 241 may have a first plug side 243 and a second plug side 245. The first plug side 243 may face the exterior of the tube 203 and the second plug side 245 may face the interior of the tube 203. The tube plug 241 may be fabricated from metallic or non-metallic material. The metallic material used to fabricate the tube plug may include, but is not limited to, carbon steel or low alloy steel. Those having skill in the art would appreciate that the tube plug may be fabricated from various materials and may have various sizes and shapes depending on size and shape of the tube.

The tube plug 241 may be configured to include a locking provision, part, or portion. According to one or more embodiments, the locking provision is a threaded provision 247. The threaded provision 247 may be located on the face of the first plug side 243 and may be a cavity or hole configured to allow access into a portion of the tube plug. The threaded provision 247 may be configured to accept and lock a complementary locking component. The threaded provision 247 may be a screw thread that has an internal helical structure used to convert between rotational and linear movement or force. The threaded provision 247 may lock a complementary threaded component, such as a complementary screw, in place.

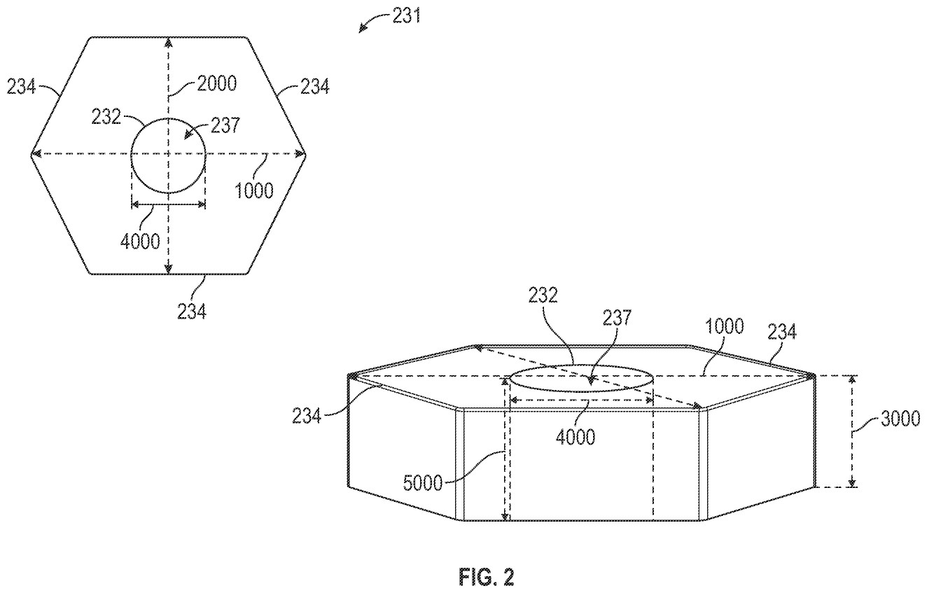

FIG. 2 shows a diagram of a ceramic ferrule according to one or more embodiments. The ceramic ferrule 231 may be defined by a length 1000, a width 2000 and a height 3000, as shown in FIG. 2 by imaginary perpendicular lines. A ceramic ferrule 231 may have a middle portion 232 that may be around the midpoint of length 1000 and the midpoint of width 2000. The ceramic ferrule 231 may be a refractory ceramic ferrule. The ceramic ferrule 231 may be configured to fit on a tube plug 241. The ceramic ferrule may be in contact with the first plug side 243 of the tube plug 241. The ceramic ferrule 231 and the first plug side 243 of the tube plug 241 may have complementary shapes configured to allow the ceramic ferrule to fit on to the first plug side 243 of the tube plug. The ceramic ferrule 231 may be configured to have a shape similar to the refractory material installed on a tubesheet 211. For example, the ceramic ferrule 231 in FIG. 2 has a hexagonal shape, however those skilled in the art would appreciate that ceramic ferrules may have several possible shapes configured to allow the ceramic ferrule to interlock with other ceramic ferrules on adjacent tubes.

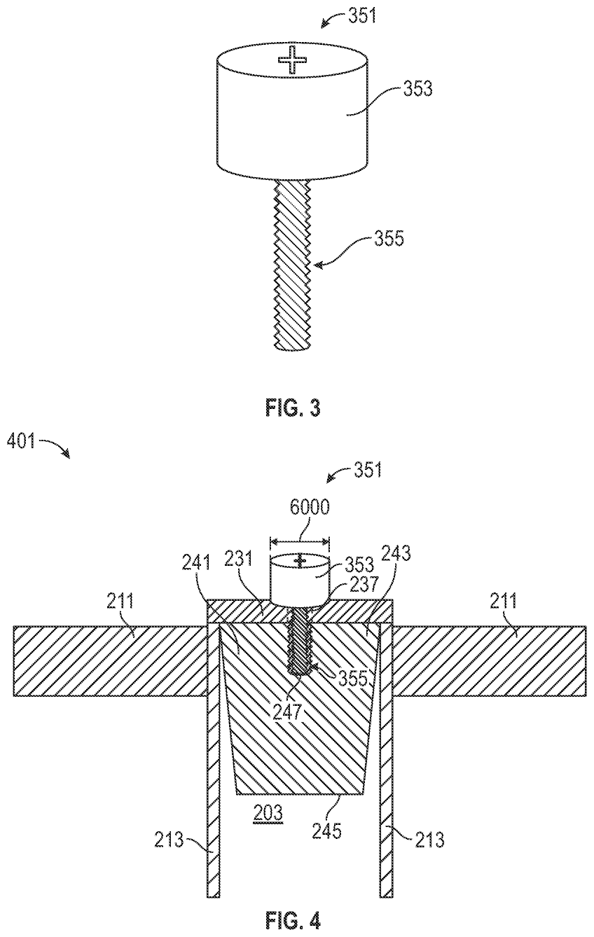

In one or more embodiments, the middle portion 232 of the ceramic ferrule 231 may have an opening 237. The opening 237 may be an aperture, passageway or gap configured to allow access or passage through the ceramic ferrule. According to one or more embodiments, the opening 237 may be a cylindrical passageway configured to fit a component. The opening 237 that is a cylindrical passageway may be defined by a diameter 4000 and the height 5000, as shown in FIG. 2 by imaginary perpendicular lines. An opening 237 that is a cylindrical passageway may have a height 5000 that is equal to the height 3000 of the ceramic ferrule such that a passageway is created though the ceramic ferrule. The diameter 4000 of the opening 237 that is a cylindrical passageway may be less than the length 1000 and width 2000 of the ceramic ferrule 231. The opening 237 may be configured to receive a ceramic plug screw 351 (FIG. 3). The ceramic ferrule 231 may have a section to lock a refractory cap onto it. Those having skill in the art would appreciate that several mechanisms and components may be used to lock the refractory cap. A refractory cap may be configured to cover the top of the ceramic plug screw 351 to provide thermal insulation for the opening 237.

FIG. 3 shows a diagram of a ceramic plug screw according to one or more embodiments. A ceramic plug screw 351 may be part of a locking mechanism configured to hold the ceramic ferrule in place. Various other locking mechanisms may be used to attach or hold the ceramic ferrule to the tube plug including, but not limited to snap-fit or bayonet connectors. A ceramic plug screw 351 may include a refractory cap that may be a plug component 353. The ceramic plug screw 351 may also include a threaded component 355. The threaded component 355 may be configured to be accepted by the threaded provision 247 on the tube plug 241 that is complementary to the threaded component 355. The plug component 353 and a threaded component 355 may be configured to inhibit exposure of the tube plug 241 and the tube to thermal radiation. According to one or more embodiments, the walls of the opening 237 of the ceramic ferrule 231 may also have screw threads complementary to the threaded component 355 of the ceramic plug screw 351. The ceramic plug screw 351 may be fabricated from refractory ceramic material. The plug component 353 and the threaded component 355 of the ceramic plug screw 351 may be fabricated from metallic or non-metallic materials. In one or more embodiments, the plug component 353 may be fabricated from ceramic material and the threaded component 355 may be fabricated from metallic materials.

The plug component 353 may be configured to attach or hold a ceramic ferrule 231 in place against the tubesheet. According to one or more embodiments, the threaded component 355 is passed through the ceramic ferrule 231 from an opening 237 that may be a cylindrical passageway and the plug component 353 may rest against the surface of the ceramic ferrule 231.

FIG. 4 shows a diagram of a ceramic tube plugging system 401 in accordance with one or more embodiments. In FIG. 4, a tubesheet 211 contains a tube 203 having a tube wall 213. A tube plug 241 may be configured to plug and isolate the tube 203. The tube plug 241 may have a first plug side 243 facing the exterior of the tube and a second plug side 245 facing the interior of the tube 203. The tube plug 241 may be configured to include threaded provision 247 on the face of the first plug side 243.

A ceramic ferrule 231 may be configured to be disposed on to the first plug side 243 of the tube plug 241. The ceramic ferrule 231 may have an opening 237 that is a cylindrical passageway configured to allow a threaded component 355 of a ceramic plug screw 351 to pass through the ceramic ferrule 231 and into the threaded provision 247 on the face of the first plug side 243. The plug component 353 of the ceramic plug screw may have a diameter 6000 as shown in FIG. 4 by an imaginary line. The threaded component 355 of the ceramic plug screw may be configured to be accepted by the complementary threaded provision 247 on the tube plug 241 allowing the ceramic plug screw 351 to be attached to the tube plug 241. The plug component 353 may be configured to hold the ceramic ferrule 231 in place against the tubesheet 211. The diameter 6000 of the plug component 353 may be greater than the diameter 4000 (as shown in FIG. 2) of the opening 237 of the ceramic ferrule 231.

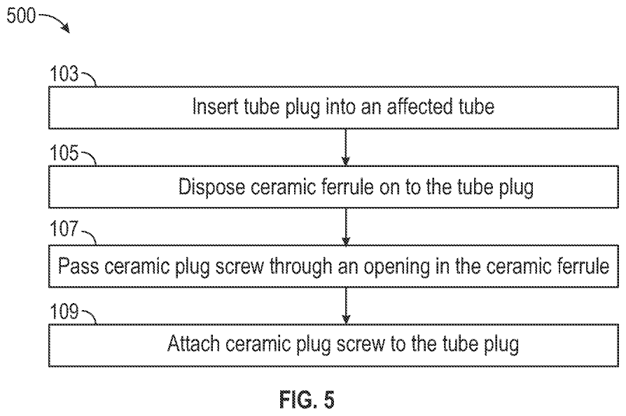

FIG. 5 is a flowchart that illustrates a method of plugging a tube in accordance with one or more embodiments.

In a method 500 of plugging a tube, a tube plug is inserted into an affected or damaged tube in step 103 according to one or more embodiments. The tube plug 241 may be hammered into the tube 203 to have a snug fit according to one or more embodiments. A side of the tube plug facing the exterior of the pipe may be used to dispose a ceramic ferrule. Further, the side of the tube plug facing the exterior of the pipe may also have a threaded provision. In step 105 the ceramic ferrule may be disposed on to the tube plug.

In a method 500 of plugging a tube, a ceramic plug screw is passed thorough the ceramic ferrule in step 107. According to one or more embodiments, this may be accomplished by passing the ceramic plug screw through an opening included in the ceramic ferrule. The opening in the ceramic ferrule may be a cylindrical passageway. Further, the tube plug may include a provision to attach a ceramic plug screw on to the tube plug. The ceramic plug screw may have a threaded component that may be inserted into the complementary threaded provision of the tube plug for attachment. According to one or more embodiments, walls of the opening in the ceramic ferrule may also include threaded provision complementary to the threaded component of the ceramic plug screw. In Step 109 the ceramic plug screw is attached to the tube plug.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A ceramic tube plugging system for plugging a tube in a tubesheet, comprising:
a tube plug with a first plug side and a second plug side configured to be inserted into the tube of the tubesheet; and
a ceramic ferrule configured to be disposed on to the first plug side of the tube plug.

2. The ceramic tube plugging system of claim 1, wherein the first plug side of the tube plug further comprises a locking mechanism configured to hold the ceramic ferrule.

3. The ceramic tube plugging system of claim 2, wherein the locking mechanism configured to hold the ceramic ferrule is a screw.

4. The ceramic tube plugging system of claim 2, wherein the locking mechanism configured to hold the ceramic ferrule is a snap-fit connector.

5. The ceramic tube plugging system of claim 1, wherein the first plug side of the tube plug further comprises a threaded provision configured to accept a complementary threaded component.

6. The ceramic tube plugging system of claim 5, further comprising a ceramic plug screw having a threaded component complementary to the threaded component of the tube plug.

7. The ceramic tube plugging system of claim 6, wherein the ceramic plug screw includes a plug component.

8. The ceramic tube plugging system of claim 1, wherein the ceramic ferrule has an opening at a middle portion of the ceramic ferrule.

9. The ceramic tube plugging system of claim 8, wherein the opening of the ceramic ferrule is a cylindrical passageway.

10. The ceramic tube plugging system of claim 9, wherein walls of the opening are threaded.

11. The ceramic tube plugging system of claim 1, wherein the tube plug is metallic.

12. A ceramic tube plugging system for plugging a tube in a tubesheet, comprising:
a tube plug with a first plug side and a second plug side configured to be inserted into the tube;
a ceramic ferrule with an opening configured to be attached to the first plug side of the ceramic tube plug; and
a ceramic plug screw.

13. The ceramic tube plugging system of claim 12, wherein the opening of the ceramic ferrule is a cylindrical passageway.

14. The ceramic tube plugging system of claim 12, wherein the ceramic plug screw includes a plug component and a threaded component.

15. The ceramic tube plugging system of claim 14, wherein the plug component is fabricated from ceramic material and the threaded component is fabricated from metallic material.

16. The ceramic tube plugging system of claim 14, wherein a diameter of the plug component of the ceramic plug screw is greater than a diameter of the opening of the ceramic ferrule.

17. A method for plugging a tube of a tubesheet, comprising:
inserting a tube plug with a threaded provision into the tube in the tubesheet;
disposing a ceramic ferrule with an opening on to the tube plug; and
attaching a ceramic plug screw to the tube plug by threading a threaded component of the ceramic plug screw into the threaded provision of the tube plug wherein the threaded component of the ceramic plug screw passes through an opening in the ceramic ferrule.
